(19) United States
(12) Patent Application Publication
(10) Pub. No.: US 2006/0229874 A1
(43) Pub. Date: Oct. 12, 2006

(54) Speech synthesizer, speech synthesizing method, and computer program

(75) Inventor: Tsutomu Kaneyasu, Tokyo (JP)

Correspondence Address: VENABLE LLP, P.O. BOX 34385, WASHINGTON, DC, 20045-9998, US

(73) Assignee: Oki Electric Industry Co., Ltd., Minato-ku (JP)

(21) Appl. No.: 11/399,410

(22) Filed: Apr. 7, 2006

(30) Foreign Application Priority Data
Apr. 11, 2005 (JP) 2005-113806

(51) Int. Cl. G10L 13/08

(52) U.S. Cl. 704/260

(57) ABSTRACT

A speech synthesizer includes a speech storage section for storing the speech of each of a plurality of speakers, a feature information storage section for storing speaker feature information which shows a feature as to the utterance of each of the speakers specified from speech, a reading feature designation section for designating reading feature information, a check section for deriving the degree of similarity of a feature as to the utterance of the speaker designated by the reading feature designation section based on the designated reading feature information and on the speaker feature information, and a speech synthesizing section for obtaining the speech of a speaker having a feature similar to the feature designated by the reading feature designation section from the speech storage section based on the derived degree of similarity and creating synthesized speech for reading a sentence based on the speech.

### CROSS REFERENCE TO RELATED APPLICATIONS

The disclosure of Japanese Patent Application No. 2005-113806, filed Apr. 11, 2005, entitled “speech synthesizer, speech synthesizing method, and computer program”. The contents of that application are incorporated herein by reference in their entirety.

### BACKGROUND OF THE INVENTION

The present invention relates to a speech synthesizer, a speech synthesizing method, and a computer program.

### DESCRIPTION OF THE RELATED ART

There is generally known a speech synthesizer for synthesizing speech that reads desired words and sentences from previously recorded human natural speech. The speech synthesizer creates synthesized speech based on a speech corpus in which natural speech that can be divided into units of part of speech is recorded. An example of a speech synthesizing processing executed by the speech synthesizer will be explained. First, an input text is subjected to a morpheme analysis and a modification analysis and converted into a phonemic symbol, an accent symbol, and the like. Next, a phoneme duration time (duration of voice), a fundamental frequency (pitch of voice), power of vowel center (magnitude of voice), and the like are estimated using the part of speech information of the input text obtained from the phonemic and accent symbol sequence and the result of the morpheme analysis. A combination of synthesizing units, which is nearest to the thus estimated phoneme duration time, fundamental frequency, and power of vowel center as well as the distortion of which is minimized when synthesizing units (phonemic segments) accumulated in a waveform dictionary are connected, is selected using a dynamic programming. Note that a scale (cost value), which is in agreement with a perceptive feature, is used in a unit selection executed here. Thereafter, speech is created by connecting the phonemic segments while converting a pitch according to a combination of the selected phonemic segments.

However, in the conventional speech synthesizer described above, it is difficult to synthesize speech of sufficient quality when a reading-tone sentence is synthesized. To cope with this problem, there is proposed a speech synthesizer that can create synthesized speech of high quality for a sentence to be read (refer to, for example, Japanese Patent Laid-Open Publication No. 2003-208188).

However, conventional speech synthesizers including that disclosed in the above document cannot determine which natural speech is to be employed as a source of synthesized speech in response to the desire of a user when the synthesized speech is created.

### SUMMARY OF THE INVENTION

Accordingly, an object of the present invention, which was made in view of the above problem, is to provide a speech synthesizer, a speech synthesizing method, and a computer program that can determine which natural speech is to be employed when synthesized speech is created in response to the desire of a user.

To solve the above problems, according to an aspect of the present invention, there is provided a speech synthesizer for creating speech for reading a sentence using a previously recorded speech. The speech synthesizer includes a speech storage section for storing the speech of each of a plurality of speakers, a feature information storage section for storing speaker feature information, which shows a feature as to the utterance of each of the speakers specified from speech, a reading feature designation section for designating reading feature information showing a feature as to an utterance when a sentence is read, a check section for deriving the degree of similarity as to the utterance of the speaker corresponding to the feature designated by the reading feature designation section based on the reading feature information designated by the reading feature designation section and on the speaker feature information stored in the feature information storage section, and a speech synthesizing section for obtaining the speech of a speaker having a feature similar to the feature designated by the reading feature designation section from the speech storage section based on the degree of similarity derived by the check section and creating a synthesized speech for reading the sentence based on the speech.

The feature as to the utterance includes a feature as to a manner of speaking, the feature of a speech, and the like. When the sentence is read, characters are read by the synthesized speech created by the speech synthesizer. Accordingly, the feature as to the utterance when the sentence is read includes the feature of the synthesized speech and the manner of speaking when the sentence is read by the synthesized speech.

According to the present invention, since the speeches of the plurality of speakers are stored in the speech storage section for each of the speakers, the speech synthesizing section can use the speeches of the plurality of speakers when the synthesized speech is created. The speech employed by the speech synthesizing section is determined based on the result of check of the check section. The check section derives the degrees of similarity of the features as to the utterances of the speakers with respect to the feature designated by the reading feature designation section. More specifically, the speech employed by the speech synthesizing section is determined based on a degree of similarity of a feature as to the utterance of a speaker as a source of utterance of the speech to the feature designated as the feature of the utterance when the sentence is read. As a result, according to the present invention, a natural speech employed when the synthesized speech is created is changed according to the designation of the reading feature information. Therefore, when, for example, the reading feature information is designated based on an input from the user, the natural speech to be employed when the synthesized speech is created can be determined in response to the desire of the user. Further, when the reading feature information is designated according to predetermined condition, the synthesized speech can be created using a different natural speech according to a circumstance even when the same sentence is read.

The speech synthesizer may further include a reading information storage section for storing a plurality of pieces of the reading feature information to each of which identification information is given and a reading feature input section that is input with the identification information. In this case, the reading feature designation section may obtain the reading feature information corresponding to the identification information from the reading information storage section based on the identification information input to the reading feature input section. According to the arrangement, since the reading feature information is designated based on the input of the user, the speech synthesizer can determine which natural speech is to be employed in response to the desire of the user when the synthesized speech is created. Further, since the user is only required to input the identification information, he or she can simply designate the reading feature information.

The speech synthesizer may include a speaker selection section for selecting a plurality of speakers who satisfy a predetermined condition based on the degree of similarity derived by the check section. In this case, the speech synthesizing section may create a plurality of pieces of synthesized speech based on the speech of each of the plurality of speakers selected by the speaker selection section. Then, the speech synthesizer may include a synthesized speech selection section for selecting a piece of synthesized speech from the plurality of pieces of synthesized speech created by the speech synthesizing section based on the value showing the degree of naturalness of the synthesized speech. According to the arrangement, the speech synthesizing section creates a plurality of pieces of synthesized speech using the speech of each of the plurality of speakers selected by a speech selection section, and one or more pieces of synthesized speech are selected from the plurality of pieces of thus created synthesized speech based on the value showing the naturalness of the synthesized speech. That is, the synthesized speech used to read a sentence is determined based on the degree of similarity of the feature as to the utterance when the sentence is read and on the naturalness of the actually created synthesized speech. Even if synthesized speech is created using the speech of the same speaker, the quality such as naturalness and the like of the synthesized speech for reading a sentence may be different depending on the sentence to be read because the amount of data and the type of the speech of each of the respective speakers stored in the speech storage section are different. Therefore, it is preferable to change speech to be employed to create synthesized speech according to a sentence to be read. With the above arrangement, when the user designates a feature as to an utterance when a sentence is read, the speech synthesizer can create synthesized speech of excellent quality that has a high degree of naturalness and is in agreement with (or near to) the desire of the user in order to read a sentence.

The speech synthesizer may include a degree of similarity storage section for storing a degree of similarity between a feature as to an utterance when a sentence, which corresponds to the reading feature information stored in the reading information storage section, is read and a feature as to the utterance of a speaker specified from the speech stored in the speech storage section, a degree of similarity obtaining section for obtaining a degree of similarity between a feature as to an utterance when a sentence, which corresponds to the reading feature information designated by the reading feature designation section, is read and a feature as to the utterances of a plurality of speakers selected by the speaker selection section, and a speaker selection section for selecting a plurality of speakers satisfying a predetermined condition based on the degree of similarity derived by the check section. In this case, the speech synthesizing section may create a plurality of pieces of synthesized speech based on the respective pieces of speech of the plurality of speakers selected by the speaker selection section. Then, the speech synthesizer may further includes a synthesized speech selection section for selecting a piece of synthesized speech from the plurality of pieces of synthesized speech created by the speech synthesizing section based on the value showing the degree of naturalness of the synthesized speech and on the degree of similarity obtained by the degree of similarity obtaining section. According to the arrangement, speech to be employed when synthesized speech is created is determined based on the degree of similarity between a sentence reading feature and the feature of the respective speakers that is derived from the check section and the degrees of similarity stored in the degree of similarity storage section. Accordingly, when a feature when a sentence is read is designated by the user, a possibility that the feature of created synthesized speech is in agreement with the desire of the user can be increased.

The synthesized speech selection section may give a weight to the value showing the degree of naturalness and to the degree of similarity. With this arrangement, the balance between the desire of the user and the degree of similarity and the naturalness of created synthesized speech can be adjusted.

The degree of similarity may be derived by calculating the difference between the speaker feature information and the reading feature information, and the predetermined condition may be a condition in which the error is equal to or less than a predetermined value.

The speech synthesizer may include a sentence input section for inputting a sentence. With this arrangement, the user can designate a sentence to be read.

The reading feature information and the speaker feature information may include a plurality of items for characterizing an utterance and numerical values set to each of the items according to the feature, and the speech synthesizer may include a reading feature input section for causing display means to display a plurality of items for characterizing the utterance and receiving the set values to the respective items from a user. With this arrangement, the user can optionally designate a feature when a sentence is read.

To overcome the above problem, according to another aspect of the present invention, there is provided a computer program for causing the speech synthesizer to function on a computer. Further, there is also provided a speech synthesizing method that can be realized by the speech synthesizer.

### BRIEF DESCRIPTION OF THE DRAWINGS

FIG. 1 is a block diagram showing a functional arrangement of a speech synthesizer according to a first embodiment of the present invention;

FIG. 2 is a table explaining the contents stored in a reading information storage section in the first embodiment;

FIG. 3 is a table explaining the contents stored in a feature information storage section in the first embodiment;

FIG. 4 is a flowchart showing a flow of a speech synthesizing processing in the first embodiment;

FIG. 5 is a block diagram showing a functional arrangement of a speech synthesizer according to a second embodiment of the present invention;

FIG. 6 is a view explaining the contents stored in a degree of similarity storage section in the second embodiment;

FIG. 7 is a flowchart showing a part of a flow of a speech synthesizing processing in the second embodiment; and

FIG. 8 is a view explaining a reading feature input section of a speech synthesizer according to a third embodiment of the present invention.

### DETAILED DESCRIPTION OF THE PREFERRED EMBODIMENTS

Preferable embodiments of the present invention will be described below in detail with reference to the accompanying drawings. Note that, in the specification and the drawings, components having substantially the same functional arrangements are denoted by the same reference numerals to omit duplicate explanation.

### First Embodiment

A speech synthesizer 10 according to a first embodiment of the present invention will be explained. The speech synthesizer 10 is input with a sentence from a user as a text as well as designated with a feature as to an utterance when the sentence is read from the user and reads the sentence input by the user by very natural synthesized speech of good quality having a feature near to the feature designated by the user. The speech synthesizer 10 includes a storage means such as a hard disc, a RAM (Random Access Memory), a ROM (Read Only memory), and the like, a CPU for controlling processing executed by the speech synthesizer 10, an input means for receiving an input by the user, an output means for outputting information, and the like. Further, the speech synthesizer 10 may include a communication means for communicating with an external computer. A personal computer, an electronic dictionary, a car navigation system, a mobile phone, a speaking robot, and the like can be exemplified as the speech synthesizer 10.

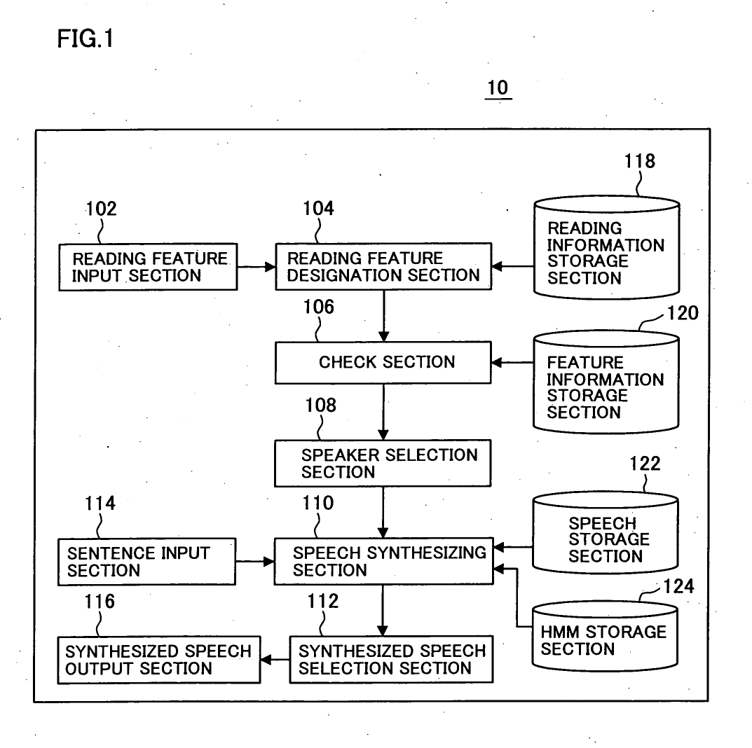

The functional arrangement of the speech synthesizer 10 will be explained with reference to FIG. 1. The speech synthesizer 10 includes a reading feature input section 102, a reading feature designation section 104, a check section 106, a speaker selection section 108, a speech synthesizing section 110, a synthesized speech selection section 112, a sentence input section 114, a synthesized speech output section 116, a reading information storage section 118, a feature information storage section 120, a speech storage section 122, and the like.

The speech storage section 122 stores the speech of each of a plurality of speakers. The speech includes a multiplicity of segments of speech when the speakers read words and sentences. In other words, the speech storage section 122 stores so-called speech corpuses of the plurality of speakers. The speech storage section 122 stores identifiers for identifying the speakers and the speech corpuses of the speakers relating to the identifiers. Note that even if speech is issued by the same speaker, when the manner of speaking and the feature of the speech are entirely different, the speech may be stored in the speech storage section 122 as the speech of other speaker.

The HMM storage section 124 stores Hidden Markov Models (hereinafter, abbreviated as HMM), which are used to estimate prosody, for a plurality of speakers. The HMM storage section 124 stores identifiers for identifying speakers and the HHMs of the speakers relating to the identifiers. The identifiers correspond to the identifiers given to the respective speakers in the speech storage section 122, and the speech synthesizing section 110 to be described later creates a synthesized speech using the speech corpus and the HMM that is caused to correspond to each other by the identifier.

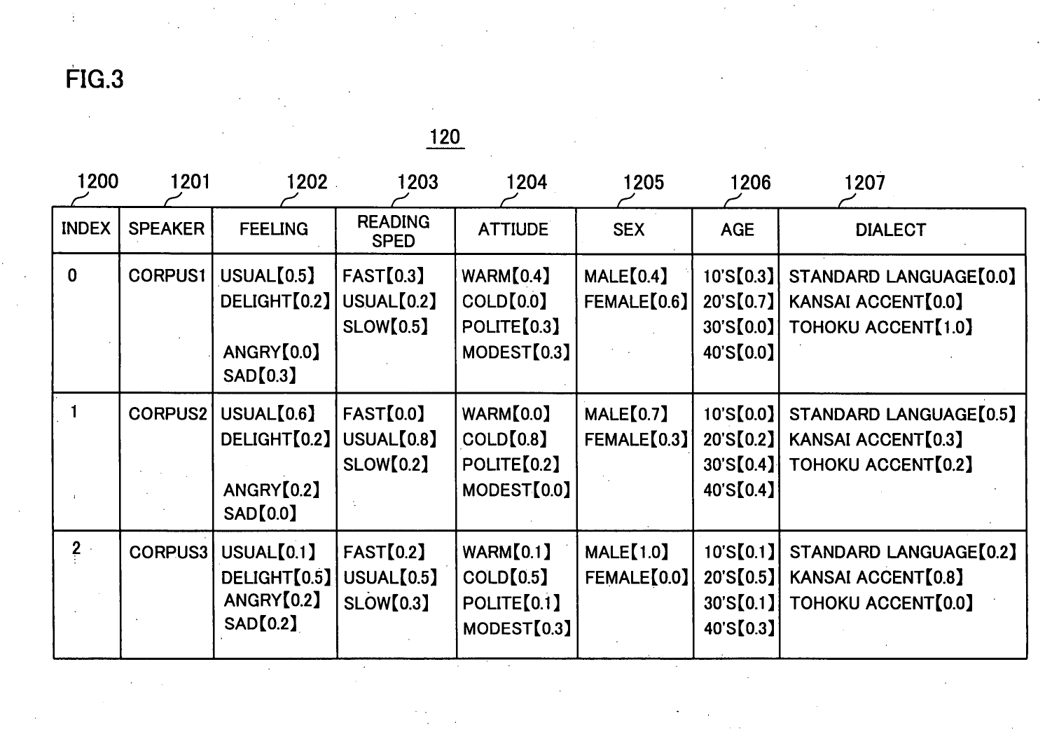

The feature information storage section 120 stores speaker feature information, which shows a feature as to each utterance of the speaker specified from the speech stored in the speech storage section 122. The feature as to the utterance of the speaker includes the feature of a manner of speaking of the speaker, the feature of speech issued from the speaker, and the like. Intonation, phrasing, a speaking speed, and the like, for example, are exemplified as the feature of the manner of speaking. A pitch of voice, impression received from speech, and the like, for example, are exemplified as the feature of the speech. The contents stored in the feature information storage section 120 will be specifically explained with reference to FIG. 3.

As shown in FIG. 3, exemplified as the items stored in the feature information storage section 120 are an Index 1200, a speaker 1201, a feeling 1202, a reading speed 1203, an attitude 1204, a sex 1205, an age 1206, a dialect 1207, and the like. Index 1200 stores identifiers for identifying speakers. The identifiers correspond to the identifiers stored in the speech storage section 122, and the speech corpuses stored in the speech storage section 122 can be related to the speaker feature information by the identifiers. The speaker 1201 stores information for specifying speakers, and stores, for example, the names of the speakers which permit the speech corpuses relating to the identifiers stored in the Index 1200 to specify the speech of respective speakers.

The feeling 1202 to the dialect 1207 are examples of the speaker feature information showing features as to the utterances of speakers. Each item has a plurality of sub-items, and the feature of a speaker in each item is expressed by the balance between the sub-items. For example, the feeling 1202 has four sub-items of usual, delightful, angry, and sad. The “feeling” is the feeling of a speaker at the time of an utterance estimated based on an impression which a hearer receives from the speech of the speaker stored in the speech storage section 122 and used as one item of the feature as to the utterance of the speaker. The feeling of the speaker in the utterance is expressed by the balance between the four sub-items. When, for example, a hearer of speech corresponding to a corpus 1 gets an impression from the speech that a speaker speaks in the usual state of mind to some extent with a little delight mixed with a little more sadness, this state of speaking is expressed by numerical values (usual=0.5, delight≦0.2, sad=0.3) allocated to the sub-items of usual, delight, and sad.

The reading speed 1203 has three sub-items of fast, usual, and slow. The “reading speed 1203” uses the reading speed of a speaker, in other words, the speed at which a speaker speaks as one item of the feature as to the utterance of the speaker based on the speech of the speakers stored in the speech storage section 122. The reading speed is expressed by the balance of the three sub-items. When for example, the reading speed of a sentence read by (a speaker of) speech corresponding to a corpus 2 is approximately usual although it is slow sometimes, the reading speed is ordinarily expressed by numerical values (usual=0.8, slow=0.2) allocated to the sub-items of usual and slow.

The attitude 1204 has four sub-items of warm, cold, polite, and modest. The “attitude” is the attitude of a speaker estimated based on the impression that a hearer gets from the speech of a speaker stored in the speech storage section 122 as one of the sub-items of the feature as to the utterance of the speaker. The attitude of the speaker at the time of the utterance of the speaker is expressed by the balance between the four sub-items. When, for example, the hearer of the speech corresponding to the corpus 1 gets an impression that the attitude of the speaker at the time of the utterance is warm, polite, and modest, the impression is expressed by numerical values (warm=0.4, polite=0.3, and modest=0.3) allocated to the sub-items of warm, polite, and modest.

The sex 1205 has two sub-items of male and female. The “sex” determines whether the manner of speaking and the tone of voice of a speaker are near to a male or to a female based on the impression that a hearer gets from the speech of the speaker stored in the speech storage section 122 and is used as one item of the feature as to the speech of the speakers. When, for example, a hearer, who hears the speech corresponding to the corpus 2 gets an impression that the manner of speaking of the speaker is womanish although the tone of voice of the speaker is a male's tone, the speech is expressed by numerical values (male=0.7, female=0.3) allocated to the sub-items of the male and the female.

The age 1206 has four sub-items of 10's, 20's, 30's, and ‘40s. The “age” is the age of a speaker that is estimated based on the impression that a hearer gets from the speech of the speaker stored in the speech storage section 122 and used as one item of the feature as to the utterance of the speaker. When, for example, a hearer of speech corresponding to the corpus 1 gets an impression that although it is estimated from the manner of speaking of a speaker that the speaker is 20's, there is a possibility that the speaker is 10's judging from the quality of voice, the age is expressed by numerical value (10's=0.3, 20's=0.7) allocated to the sub-items of 10's and 20's.

The dialect 1207 has three sub-items of a standard language, a Kansai accent (accent used in a Kansai district), and a Tohoku accent (accent used in a Tohoku district). The “dialect” uses the dialect of a speaker as one item of a feature as to the utterance of the speaker from the speech of the speaker stored in the speech storage section 122, in particular, from intonation and the kinds of languages in use. When, for example, speech corresponding to a corpus 3 is spoken approximately by the Kansai accent judging from intonation and the like at the time a sentence is read by (a speaker of) the speech but the Kansai accent is not a perfect Kansai accent and somewhat includes the standard language, this is expressed by numerical values (standard language=0.2, Kansai accent=0.8) allocated to the sub-items of the standard language and the Kansai accent.

The items and the sub-items described above are only examples and any arbitrary items and sub-items may be set. Further, the feature may be expressed by storing any of numerical values 0 to 10 every item, for example, in place of setting the sub-items to each item and expressing the feature by the balance of the sub-items. Specifically, for example, the feature may be expressed by providing a “reading speed is fast” as an item, 10 is stored when the speed is very fast, 0 is stored when the speed is very slow, and, numerical values 1-9 are stored to speeds therebetween. Tile feature information storage section 120 has been explained above in detail.

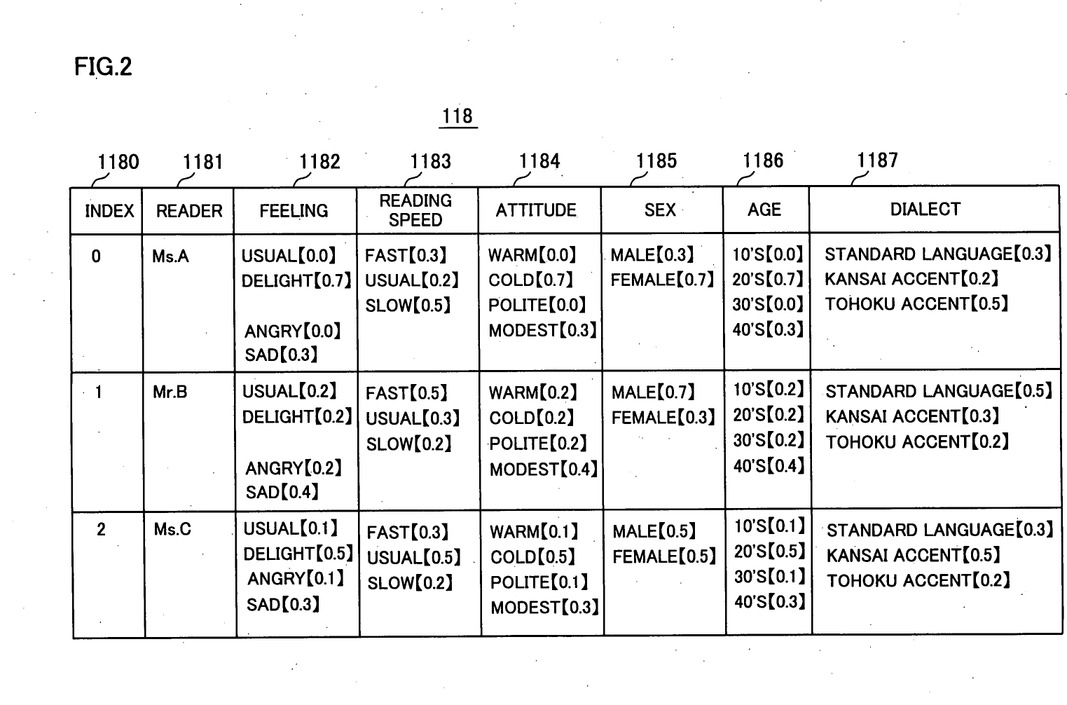

Returning to FIG. 1, the reading information storage section 118 stores a plurality of pieces of reading feature information. An identifier is given to each of the plurality of pieces of reading feature information. The reading feature information shows a feature as to an utterance when a sentence is read. The feature information storage section 120 described above stores the information of a feature as to the utterance of each speaker corresponding to the speech of the speakers stored in the speech storage section 122. In contrast, the reading information storage section 118 stores the information of a feature, which is desired to be provided in synthesized speech when it is output from the synthesized speech output section 116, as the information of a feature as to an utterance stored in the reading information storage section 118. The contents stored in the reading information storage section 118 will be explained with reference to FIG. 2.

As shown in FIG. 2, exemplified as the items stored in the reading information storage section 118 are an Index 1180, a reader 1181, a feeling 1182, a reading speed 1183, an attitude 1184, a sex 1185, an age 1186, a dialect 1187, and the like. The Index 1180 stores an identifier for identifying the reading feature information. The reader 1181 stores information for specifying the reading feature information. The information may be used to permit the user to designate any piece of the reading feature information stored in the reading information storage section 118. In this case, the reader 1181 stores names from which the user can easily estimate the contents of the reading feature information. Specifically, when the reading feature information identified by, for example, Index=0 is information showing a feature as to the utterance of a hero of animation, the reader 1181 stores the name of the hero of the animation. When the user can designate the name of the hero of the animation at the time he or she designates the reading feature information, the user can designate the reading feature information after he or she approximately recognizes what feature the synthesized speech has when a sentence is read. Note that when the user designates the reading feature information, he or she may use the identifier stored in the Index 1180.

The feeling 1182 to the dialect 1187 are examples of the reading feature information as to an utterance in reading. Each item has a plurality of sub-items, and the feature of a speaker in each item is shown by the balance between the sub-items. The kinds of the items and the sub-items correspond to those stored in the feature information storage section 120. Note that all of the items and the sub-items need not correspond thereto. Since the meanings of the respective items and the sub-items are the same as those explained in the feature information storage section 120, the explanation of them is omitted. The reading information storage section 118 has been explained above in detail.

The reading information storage section 118, the feature information storage section 120, and the speech storage section 122 are stored in a storage means of the speech synthesizer 10.

Returning to FIG. 1, the explanation of the functional arrangement of the speech synthesizer 10 will be continued. The user inputs the reading feature information to the reading feature input section 102. In the embodiment, identification information corresponding to any of the pieces of the reading feature information stored in the reading information storage section 118 is input as the reading feature information. The identification information may be the name of a reader as described above or may be an Index (identifier). The identification information input to the reading feature input section 102 is supplied to the reading feature designation section 104.

The reading feature designation section 104 extracts the reading feature information, which corresponds to the identification information, from the reading information storage section 118 based on the identification information obtained from the reading feature input section 102. At the time, the reading feature designation section 104 may extract all the items (the feeling 1182 to the dialect 1187) stored in the reading information storage section 118 or may extract a part of them (for example, only the reading speed 1183 and the dialect 1187). The user may designate items to be extracted from the reading feature input section 102. The reading feature designation section 104 supplies the extracted reading feature information to the check section 106.

The check section 106 obtains the reading feature information from the reading feature designation section 104 and checks the obtained reading feature information with the speaker feature information stored in the feature information storage section 120. The check section 106 derives the degree of similarity between the reading feature information and each of a plurality of pieces of the speaker feature information by executing the check. Specifically, the degree of similarity can be derived by determining an error between the pieces of the feature information. The error therebetween can be determined by, for example, a least squares method as shown below.

The values of the sub-items of the reading feature information: Uᵤₛᵤₐₗ, U_{delight}, U_{sad}, . . . , U_{warm}, . . . , U_{Tohoku} accent, the values of the sub-items of the speaker feature information: Cᵤₛᵤₐₗ, C_{delight}, C_{sad}, . . . , C_{warm}, . . . , C_{Tohoku} accent, Error=(Uᵤₛᵤₐₗ−Cᵤₛᵤₐₗ)²+(U_{delight}−C_{delight})²+(U_{sad}−C_{sad})²+ . . . +(Uₐᵣₘ−C_{warm})²+ . . . +(U_{Tohoku} accent−C_{Tohoku} accent)²

Further, the respective items of the above equation may be weighted to reflect the items whose degree of similarity is emphasized and the items whose degree of similarity is not emphasized to the result of calculation. The check section 106 supplies the derived degree of similarity, specifically, the result calculated from the above expression to the speaker selection section 108 together with the identifier (Index 1200) of the speaker feature information. Note that the check section 106 may check the speaker feature information of all the speakers stored in the feature information storage section 120 with the reading feature information or may check the speaker feature information of a part of the speakers therewith by filtering the speakers by a sex or an age.

The speaker selection section 108 selects a plurality of speakers based on the degree of similarity obtained from the check section 106. Specifically, the speaker selection section 108 obtains a plurality of identifiers of the speaker feature information and the errors as the result of calculation corresponding to the respective identifiers and selects at least two pieces of the speaker feature information based on a predetermined condition. A condition, for example, that the errors are within a predetermined range may be employed as the predetermined condition. Further, the predetermined number of errors in the order of smaller errors may be employed as the predetermined condition. The speaker selection section 108 supplies the identifiers of the selected speaker feature information to the speech synthesizing section 110.

The sentence input section 114 is input with a sentence (including a case of only one sentence and only one word) to be read by synthesized speech and supplies the input sentence to the speech synthesizing section 110. The sentence may be input by the user through an input means such as a keyboard and the like or may be input from other computer and the like through a communication means. Further, the sentence may be input by reading a text sentence recorded in an external recording medium such as a flexible disc, a CD (Compact Disk), and the like.

The speech synthesizing section 110 creates a plurality of synthesized speeches based on the speech of each of the plurality of speakers selected by the speaker selection section 108. Specifically, the speech synthesizing section 110 creates the synthesized speech for reading the sentence obtained from the sentence input section 114 by obtaining the plurality of identifiers of the speaker feature information from the speaker selection section 108, creating prosodies of the respective speakers based on the HMMs corresponding to the obtained identifiers, and selecting phoneme waveforms corresponding to the created prosodies of the respective speakers from the speech corpuses of the respective speakers and connecting them. In more detail, the speech synthesizing section 110 creates the synthesized speech by the following processings.

1. The input sentence is subjected to a morpheme analysis and a modification analysis, and the sentence written by Chinese and kana characters into prosody symbols, accent symbols, and the like.

2. A phoneme duration, a fundamental frequency, melcepstrum, and the like that are feature points are estimated using the statistically studied HMM, which is constructed from the speech stored in the speech storage section 122 and stored in the HMM storage section 124, based on the part of speech information of the sentence obtained from a phonemic symbol sequence, an accent symbol sequence, and the result of the morpheme analysis.

3. A combination of synthesizing units (phonemic segments) from the leading end of the sentence, in which a cost value is minimized, is selected using a dynamic programming based on the cost value calculated by a cost function.

4. The phonemic segments are connected to each other according to the combination of the phonemic segments selected above.

The cost function is composed of five sub-cost functions, that is, a sub-cost as to prosody, a sub-cost as to discontinuity of a pitch, a sub-cost as to replacement of a phonemic environment, a sub-cost as to discontinuity of spectrum, and a sub-cost as to adaptability of phoneme and determines a degree of naturalness of synthesized speech. The cost value is a value obtained by multiplying the sub-cost values calculated from the five sub-cost functions by weight coefficients and adding the resultant sub-cost values and an example of a value showing the degree of naturalness of the synthesized speech. A smaller cost value shows a higher degree of naturalness of synthesized speech. Note that the speech synthesizing section 110 may create synthesized speech by any method different from the above method as long as the method can calculate a value showing the degree of naturalness of synthesized speech.

The speech synthesizing section 110 supplies a plurality of pieces of the created synthesized speech and the cost values thereof to the synthesized speech selection section 112.

The synthesized speech selection section 112 selects a piece of the synthesized speech to be output from the plurality of pieces of the synthesized speech obtained from the speech synthesizing section 110 based on the value showing the degree of naturalness of the synthesized speech. Specifically, the synthesized speech selection section 112 obtains the plurality of pieces of the synthesized speech and the cost values thereof from the speech synthesizing section 110, selects a piece of the synthesized speech having a minimum cost value as synthesized speech to be output, and supplies the piece of the selected synthesized speech to the synthesized speech output section 116.

The synthesized speech output section 116 outputs the synthesized speech obtained from the synthesized speech selection section 112. When the synthesized speech is output, the sentence input by the sentence input section 114 is read by the synthesized speech.

The functional arrangement of the speech synthesizer 10 has been explained above. It should be noted that all the functions may be built in a single computer and operated as the speech synthesizer 10, or the respective functions may be discretely built in a plurality of computers and operated as the single speech synthesizer 10 as a whole.

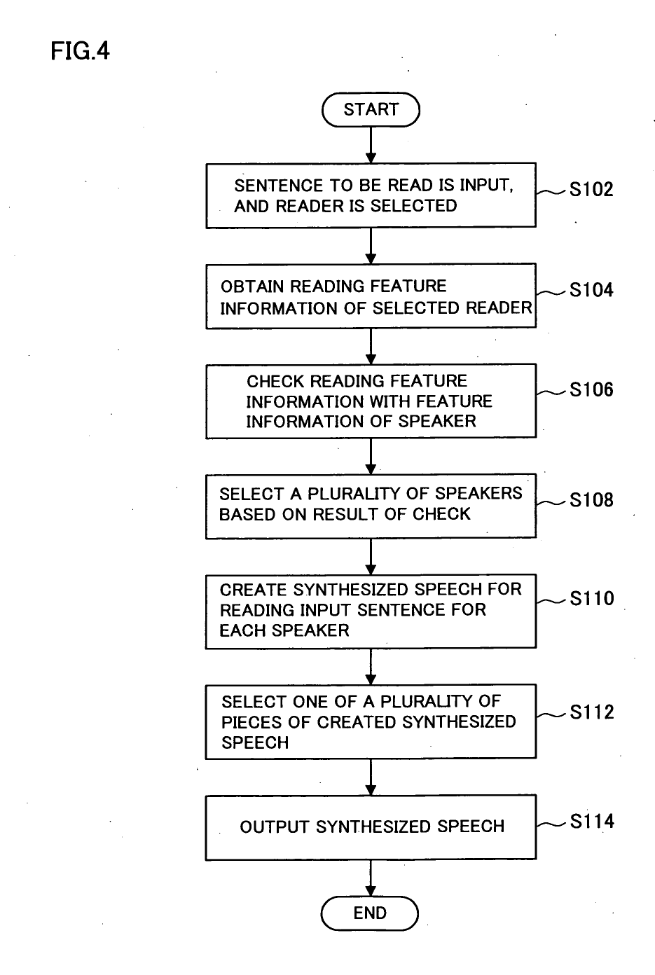

Next, a flow of a speech synthesizing processing executed by the speech synthesizer 10 will be explained with reference to FIG. 4. First, a sentence to be read is input to the sentence input section 114, and a reader (identification information of the reading feature information) is selected through the reading feature input section 102 (S102). The reading feature designation section 104 obtains the reading feature information corresponding to the reader selected at S102 from the reading information storage section 118 (S104). Next, the check section 106 checks the reading feature information with the speaker feature information stored in the feature information storage section 120 (S106). Next, the speaker selection section 108 selects a plurality of speakers based on the result of check at S106 (S108). Next, the speech synthesizing section 110 creates synthesized speech for reading the sentence input at step S102 based on the speech corpus of the speaker selected at S108 and the HMM (S110). Then, the synthesized speech selection section 112 selects a piece of synthesized speech from the plurality of pieces of synthesized speech created at S110 based on the cost values thereof (S112). Finally, the synthesized speech output section 116 outputs the piece of the synthesized speech selected at S112 (S114).

The flow of the speech synthesizing processing has been explained above. When synthesized speech is created, the speech synthesizer 10 according to the embodiment can determine which natural speech is to be employed in response to a desire of the user by arranging the speech synthesizer 10 as described above. Further, the speech synthesizer 10 can change speech, which is employed when the synthesized speech is created, according to a sentence to be read. As a result, the speech synthesizer 10 can create synthesized speech of excellent quality that has a high degree of naturalness and is in agreement with (or near to) the desire of the user in order to read a sentence.

### Second Embodiment

A speech synthesizer 20 according to a second embodiment of the present invention will be explained. The speech synthesizer 20 is input with a sentence from a user as a text as well as designated with a feature as to an utterance when the sentence is read from the user and reads the sentence input by the user by very natural synthesized speech of good quality having a feature near to the feature designated by the user. Further, the speech synthesizer 20 more securely reads synthesized speech having a feature near to the feature designated by the user. Since a hardware arrangement of the speech synthesizer 20 is almost the same as the speech synthesizer 10 according to the first embodiment, the explanation thereof is omitted.

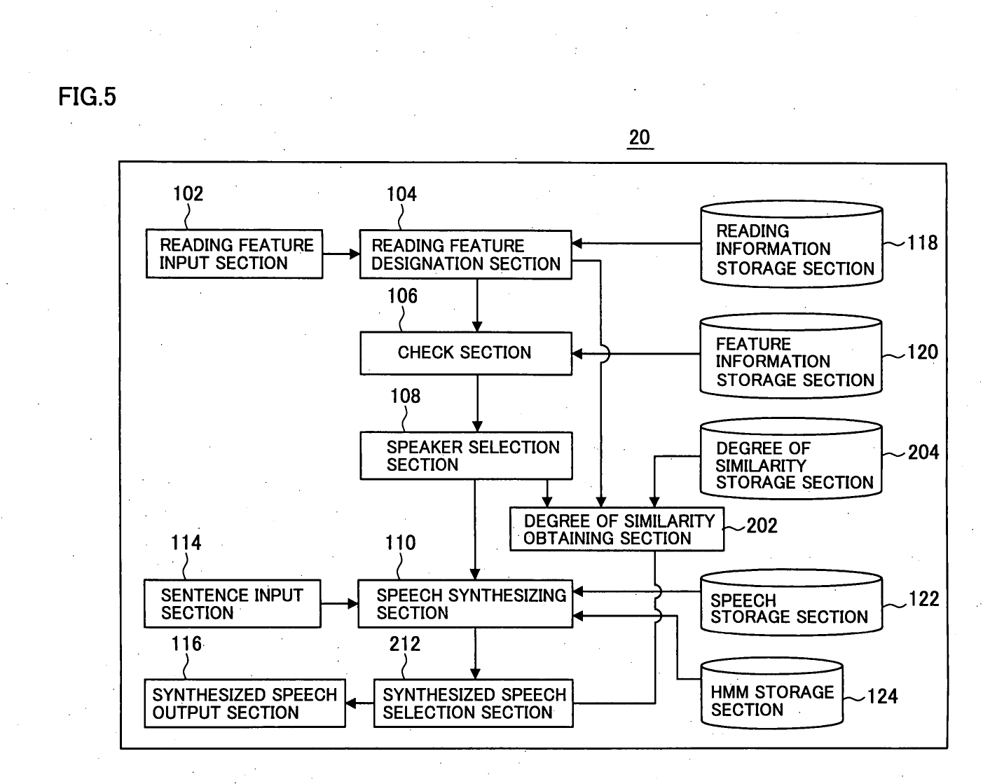

A functional arrangement of the speech synthesizer 20 will be explained with reference to FIG. 5. The speech synthesizer 20 includes a reading feature input section 102, a reading feature designation section 104, a check section 106, a speaker selection section 108, a degree of similarity obtaining section 202, a speech synthesizing section 110, a synthesized speech selection section 212, a sentence input section 114, a synthesized speech output section 116, a reading information storage section 118, a feature information storage section 120, a degree of similarity storage section 204, a speech storage section 122, and the like. The sections having the same functions as the speech synthesizer 10 according to the first embodiment are denoted by the same reference numerals, and the explanation thereof is omitted.

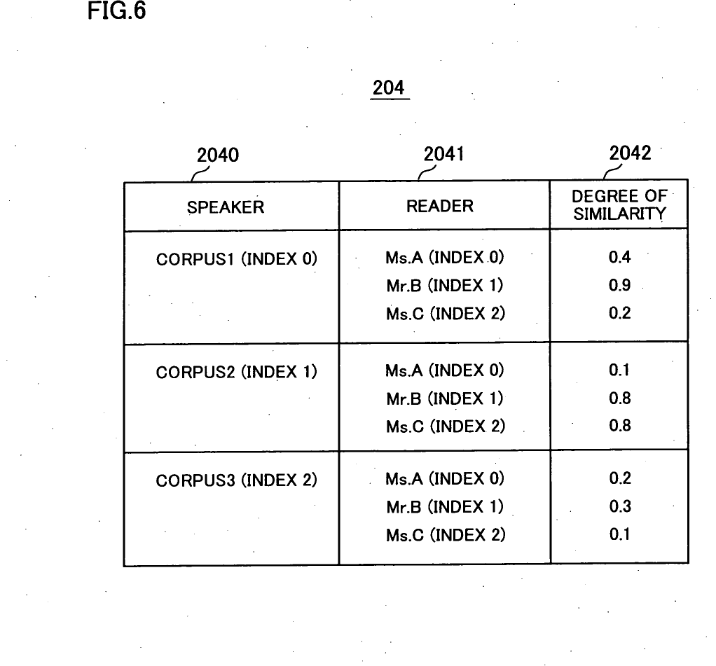

The degree of similarity storage section 204 stores a degree of similarity between a feature as to an utterance when a sentence, which corresponds to the reading feature information stored in the reading information storage section 118, is read and a feature as to the utterance of a speaker specified from the speech stored in the speech storage section 122. The contents stored in the feature information storage section 204 will be explained in detail with reference to FIG. 6.

As shown in FIG. 6, a speaker 2040, a reader 2041, a degree of similarity 2042, and the like are exemplified as the items stored in the degree of similarity storage section 204. The speaker 2040 stores information for specifying a speaker likewise the speaker 1201 as an item in the feature information storage section 120. Further, the speaker 2040 also stores an identifier (Index 1200) that uniquely identifies the speaker in the feature information storage section 120. The reader 2041 stores information for specifying the reading feature information likewise the reader 1181 as an item in the reading information storage section 118. Further, reader 2041 also stores an identifier (Index 1180) for uniquely identifying the reader in the reading information storage section 118.

The degree of similarity 2042 stores a degree of similarity between a feature in the utterance of a speaker (speech corpus) corresponding to the identification information stored in the speaker 2040 and a feature of an utterance when a reader corresponding to the identification information stored in the reader 2041 reads. As shown in the figure, it is preferable to store the degrees of similarity of all the readers in the reading information storage section 118 to respective speakers. The degree of similarity may be a degree of similarity that is previously determined by a hearer based on manners of speaking of speakers (for example, a hero of an animation and the like) acting as models of the respective readers in the reading information storage section 118 and on the voices of the speech corpuses of the respective speakers stored in the speech storage section 122. Further, the degree of similarity may be a degree of similarity determined by the analysis and the like of the speech of both of them. According to the illustrated example, the degree of similarity is shown by a numerical value of 0.0 to 1.0, wherein 1.0 shows complete dissimilarity and 0.0 shows great similarity.

Returning to FIG. 5, the explanation of the functional arrangement of the speech synthesizer 20 will be continued. The degree of similarity obtaining section 202 obtains a degree of similarity between a feature as to an utterance when a sentence, which corresponds to the reading feature information designated by the reading feature designation section 104, is read and a feature as to the utterances of a plurality of speakers selected by the speaker selection section 108 from the degree of similarity storage section 204. Specifically, the degree of similarity obtaining section 202 obtains the identification information (Index) of the selected speakers from the speaker selection section 108 and obtains the identification information (Index) of the readers from the reading feature designation section 104. Then, the degree of similarity obtaining section 202 obtains a corresponding degree of similarity referring to the degree of similarity storage section 204 based on the obtained identification information of the speakers and the obtained identification information of the readers. The degree of similarity obtaining section 202 supplies the obtained degree of similarity and the identification information of the speaker corresponding to the degree of similarity to the synthesized speech selection section 212.

The synthesized speech selection section 212 obtains a plurality of pieces of synthesized speech created by the speech synthesizing section 110, identification information (Indexes of speakers) for identifying speech corpuses as sources of the respective pieces of synthesized speech, and cost values corresponding to the respective pieces of synthesized speech from the speech synthesizing section 110, and obtains the degrees of similarity of the respective speakers extracted by the degree of similarity obtaining section 202 from the degree of similarity storage section 204 from the degree of similarity obtaining section 202. Then, the synthesized speech selection section 212 selects a piece of synthesized speech from the plurality of pieces of synthesized speech based on the obtained cost values and the obtained degrees of similarity. In the embodiment, a lower cost value shows a higher degree of naturalness, and a smaller numerical value shows a higher degree of similarity. Thus, the synthesized speech selection section 212 determines a value obtained by adding the cost value and the value of the degree of similarity as to each of the speakers and selects the synthesized speech created by the speech of the speaker who has the minimum added value as synthesized speech to be output.

Further, the synthesized speech selection section 212 may obtain the added value of the cost value and the value of the degree of similarity after they are weighted. A case, in which the cost value of the speaker of Index=1 is 0.1 and the degree of similarity of the speaker is 0.6, and the cost value of the speaker of Index=2 is 0.5 and the degree of similarity of the speaker is 0.1, will be explained as an example. When a speaker whose value obtained by simply adding the cost value and the value of the degree of similarity is minimized is selected, since the value of the speaker of Index=1 is 0.7 and the value of the speaker of Index=2 is 0.6, the speaker of Index=2 is selected. In contrast, when a speaker whose value obtained by adding the cost value and the value of the degree of similarity is minimized is selected after a weight coefficient of 0.8 is given to the cost value and a weight coefficient of 0.2 is given to the value of the degree of similarity, since the value of the speaker of Index=1 is 0.20 and the value of the speaker of Index=2 is 0.42, the speaker of Index=1 is selected. A degree of importance given to the naturalness and the degree of similarity of synthesized speech can be adjusted by giving the weights thereto by the synthesized speech selection section 212.

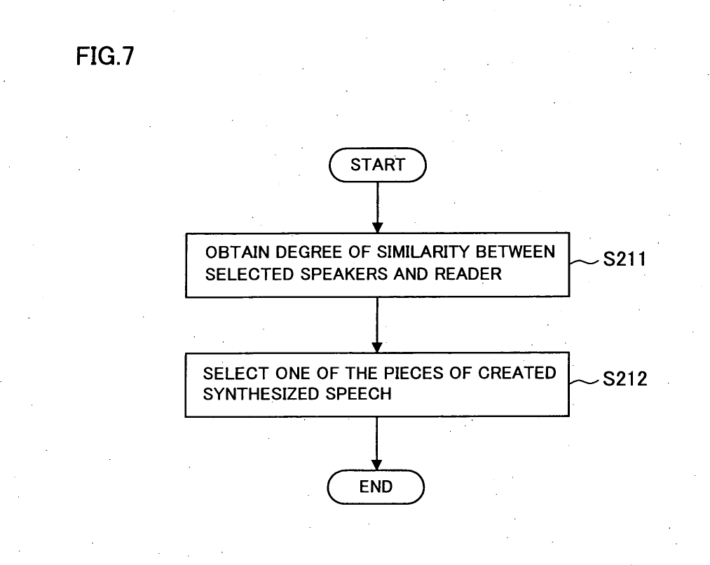

The functional arrangement of the speech synthesizer 20 has been described above mainly as to the portions different from the first embodiment. Next, a flow of a speech synthesizing processing executed by the speech synthesizer 20 will be explained with reference to FIG. 7.

The explanation of the portions of the flow of the speech synthesizing processing similar to those of the first embodiment are omitted. FIG. 7 shows processings that are not executed in the first embodiment. A processing executed at S211 of FIG. 7 is executed after the processing at step S110 of FIG. 4 showing the flow of the speech synthesizing processing in the first embodiment. The processing executed at S212 of FIG. 7 is executed in place of the processing executed at S 112 of FIG. 4.

At S211, the degree of similarity obtaining section 202 obtains the degrees of similarity between the speakers and the reader selected by the speaker selection section 108 at S108 from the degree of similarity storage section 204 (S211). Then, the synthesized speech selection section 112 selects a piece of synthesized speech from the plurality of pieces of synthesized speech created by the speech synthesizing section 110 at S110 based on the cost values and the degrees of similarity.

Note that the processing executed at S211 may be executed after S108 and before S110 of FIG. 4. The flow of the speech synthesizing processing executed by the speech synthesizer 20 has been explained above.

When synthesized speech is created, the speech synthesizer 20 according to the embodiment can determine which natural speech is to be employed in response to a desire of the user by arranging the speech synthesizer 20 as described above. Further, the speech synthesizer 20 can change speech employed when the synthesized speech is created according to a sentence to be read. As a result, the speech synthesizer 20 can create synthesized speech of excellent quality that has a high degree of naturalness and is in agreement with (or near to) the desire of the user in order to read a sentence. Further, in the speech synthesizer 20, since the speech, which is employed to create synthesized speech, is determined based on the degrees of similarity between a sentence reading feature and the features of the respective speakers and on the degrees of similarity stored in the degree of similarity storage section, a possibility that the feature of created synthesized speech is in agreement with the desire of the user can be increased.

### Third Embodiment

A speech synthesizer 30 according to a third embodiment of the present invention will be explained. The speech synthesizer according to the embodiment is input with a sentence from a user as a text as well as designated with a feature as to an utterance when the sentence is read from the user and reads the sentence input by the user by very natural synthesized speech of good quality having a feature near to the feature designated by the user. Further, the speech synthesizer according to the embodiment permits the user to designate any arbitrary feature information. Since a hardware arrangement of the speech synthesizer is approximately the same as the speech synthesizer 10 according to the first embodiment, the explanation thereof is omitted.

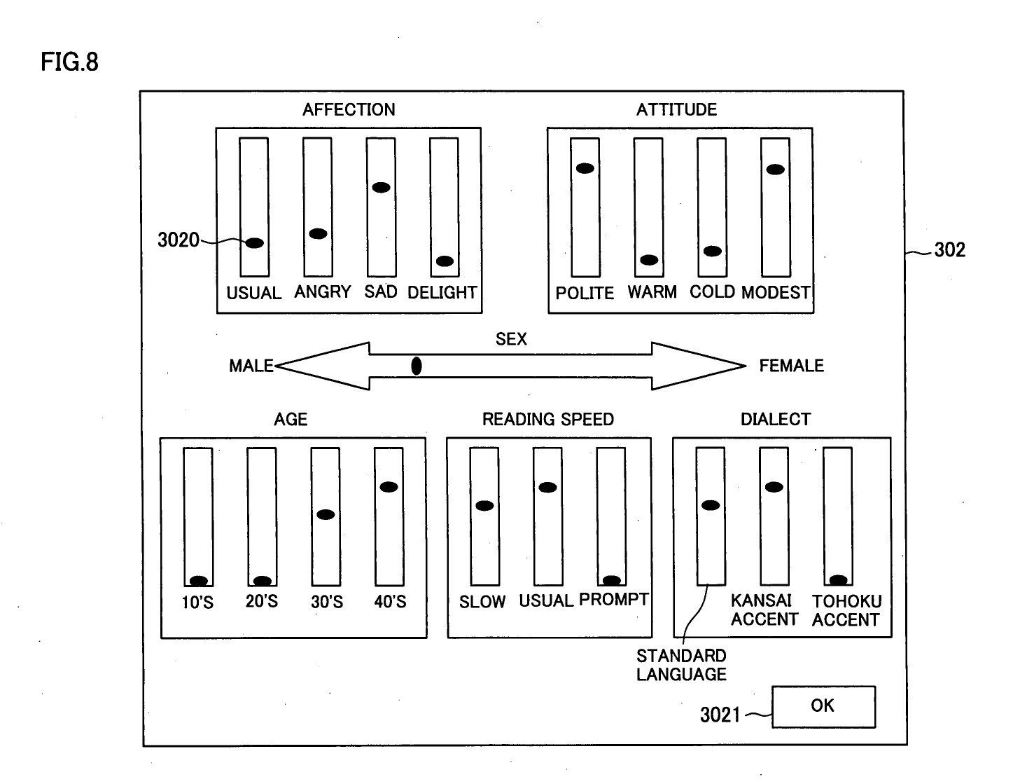

Although a functional arrangement of the speech synthesizer is approximately the same as the speech synthesizer 10 according to the first embodiment, it is different therefrom in that the reading information storage section 118 is not necessary and the reading feature information input to the reading feature input section 102 is not identification information corresponding to the reading feature information. Only the portions of the third embodiment different from those of the first embodiment will be explained below and the explanation of the portions similar to those of the first embodiment is omitted. In the first embodiment, the user selects the reading feature information previously stored in the reading information storage section 118. However, in the speech synthesizer of this embodiment, the user can optionally designate reading feature information through a reading feature input section 302. The reading feature input section 302 will be explained with reference to FIG. 8.

The reading feature input section 302 includes a display means such as a display, a pointing device such as a mouse and the like, an input means such as a keyboard, and the like provided in the speech synthesizer. FIG. 8 shows an example of a screen through which reading feature information to be displayed on the display means is input. The screen displays items, which correspond to the respective items of the speaker feature information stored in a feature information storage section 120, and the sub-items thereof. The sub-items include sliders 3020 for adjusting the values thereof, and the user inputs the reading feature information after he or she adjusts the values of the sub-items by adjusting the sliders 3020 through the input means. When an OK button 3021 is depressed, the reading feature information input by the user is supplied to a reading feature designation section 104. Note that the sub-items may be adjusted by the sliders 3020 as in the illustrated example or may be adjusted by inputting numerical values.

The speech synthesizer according to the third embodiment of the present invention have been explained above. The user can arbitrarily designate a feature as an utterance when a sentence is read by arranging the speech synthesizer as described above.

Although the preferable embodiments of the present invention have been explained above with reference to the accompanying drawings, it is needless to say that the present invention is by no means limited thereto. It is apparent that persons skilled in the art can conceive various modifications and corrections within the scope of the appended claims, and it should be understood that these modifications and corrections also belong to the technical scope of the present invention as a matter of course.

As described above, according to the present invention, there can be provided the speech synthesizer, the speech synthesizing method, and the computer program that can determine which natural speech is to be employed in response to a desire of a user when synthesized speech is created.

The present invention can be applied to a speech synthesizer for creating speech for reading a sentence using previously recorded speech.

What is claimed is:

1. A speech synthesizer for creating speech for reading a sentence using previously recorded speech comprising:
a speech storage section for storing the speech of each of a plurality of speakers;
a feature information storage section for storing speaker feature information, which shows a feature as to the utterance of each of the speakers specified from speech;
a reading feature designation section for designating reading feature information showing a feature as to an utterance when a sentence is read;
a check section for deriving the degree of similarity as to the utterance of the speaker corresponding to the feature designated by the reading feature designation section based on the reading feature information designated by the reading feature designation section and on the speaker feature information stored in the feature information storage section; and
a speech synthesizing section for obtaining the speech of a speaker having a feature similar to the feature designated by the reading feature designation section from the speech storage section based on the degree of similarity derived by the check section and creating a synthesized speech for reading the sentence based on the speech.

2. A speech synthesizer according to claim 1, comprising:
a reading information storage section for storing a plurality of pieces of the reading feature information to each of which identification information is given; and
a reading feature input section that is input with the identification information,
wherein the reading feature designation section obtains the reading feature information corresponding to the identification information from the reading information storage section based on the identification information input to the reading feature input section.

3. A speech synthesizer according to claim 1, comprising a speaker selection section for selecting a plurality of speakers who satisfy a predetermined condition based on the degree of similarity derived by the check section,
wherein the speech synthesizing section creates a plurality of pieces of synthesized speech based on the speech of each of the plurality of speakers selected by the speaker selection section; and
the speech synthesizer comprises a synthesized speech selection section for selecting a piece of synthesized speech from the plurality of pieces of synthesized speech created by the speech synthesizing section based on the value showing the degree of naturalness of the synthesized speech.

4. A speech synthesizer according to claim 2, comprising:
a degree of similarity storage section for storing a degree of similarity between a feature as to an utterance when a sentence, which corresponds to the reading feature information stored in the reading information storage section, is read and a feature as to the utterance of a speaker specified from the speech stored in the speech storage section;
a degree of similarity obtaining section for obtaining a degree of similarity between a feature as to an utterance when a sentence, which corresponds to the reading feature information designated by the reading feature designation section, is read and a feature as to the utterances of a plurality of speakers selected by the speaker selection section; and
a speaker selection section for selecting a plurality of speakers who satisfy a predetermined condition based on the degree of similarity derived by the check section,
wherein the speech synthesizing section creates a plurality of pieces of synthesized speech based on the respective pieces of speech of the plurality of speakers selected by the speaker selection section; and
the speech synthesizer further comprises a synthesized speech selection section for selecting a piece of synthesized speech from the plurality of pieces of synthesized speech created by the speech synthesizing section based on the value showing the degree of naturalness of the synthesized speech and on the degree of similarity obtained by the degree of similarity obtaining section.

5. A speech synthesizer according to claim 4, wherein the synthesized speech selection section gives a weight to the value showing the degree of naturalness of the synthesized speech and to the degree of similarity.

6. A speech synthesizer according to claim 3, wherein the degree of similarity is derived by calculating the difference between the speaker feature information and the reading feature information, and the predetermined condition is a condition in which the error is equal to or less than a predetermined value.

7. A speech synthesizer according to claim 4, wherein the degree of similarity is derived by calculating the difference between the speaker feature information and the reading feature information, and the predetermined condition is a condition in which the error is equal to or less than a predetermined value.

8. A speech synthesizer according to claim 1, comprising a sentence input section for inputting the sentence.

9. A speech synthesizer according to claim 1, wherein the reading feature information and the speaker feature information include a plurality of items for characterizing an utterance and numerical values set to each of the items according to the feature.

10. A speech synthesizer according to claim 9, comprising a reading feature input section for causing display means to display a plurality of items for characterizing the utterance and receiving the set values to the respective items from a user.

11. A computer program for causing a speech synthesizer, which creates speech for reading a sentence using previously recorded speech, to execute:
a reading feature designation processing for designating reading feature information showing a feature as to an utterance when a sentence is read;
a check processing for deriving the degrees of similarity of features as to the utterances of speakers to the feature designated by the reading feature designation processing based on the speaker feature information in a feature information storage section in which speaker feature information, which shows a feature as to the utterance of each of the speakers specified from speech, is stored and on the reading feature information designated by the reading feature designation processing; and
a speech synthesizing processing for obtaining the speech of a speaker having a feature similar to the feature designated by the reading feature designation processing from a speech storage section in which the speech of each of a plurality of speakers are stored based on the degrees of similarity derived by the check processing and creating synthesized speech for reading the sentence based on the speech.

12. A speech synthesizing method of creating speech for reading a sentence using previously recorded speech comprising:
a speech storage step of storing the speech of each of a plurality of speakers in storage means;
a feature information storage step of storing speaker feature information showing a feature as to the utterance of each of the speakers specified from the speech in storage means;
a reading feature designation step of designating reading feature information showing a feature as to an utterance when a sentence is read;
a check step of deriving degrees of similarity of features as to the utterances of the speakers to the feature designated by the reading feature designation step based on the reading feature information designated by the reading feature designation step and on the speaker feature information stored in the storage means; and
a speech synthesizing step of obtaining the speech of a speaker having a feature similar to the feature designated by the reading feature designation step from the storage means based on the degrees of similarity derived by the check step and creating synthesized speech for reading the sentence based on the speech.
